(19) United States
(12) Patent Application Publication
(10) Pub. No.: US 2005/0206594 A1
(43) Pub. Date: Sep. 22, 2005

(54) LIQUID CHRYSTAL DISPLAY DEVICE

(75) Inventor: Noriyuki Suzuki, Mori-machi (JP)

Correspondence Address: ERNEST A. BEUTLER, ATTORNEY AT LAW, 10 RUE MARSEILLE, NEWPORT BEACH, CA, 92660, US

(73) Assignee: KABUSHIKI KAISHA MORIC, Mori-machi (JP)

(21) Appl. No.: 10/906,845

(22) Filed: Mar. 9, 2005

(30) Foreign Application Priority Data
Mar. 19, 2004 (JP) 2004-079549

(51) Int. Cl. G02F 1/1335

(52) U.S. Cl. 345/87

(57) ABSTRACT

A liquid crystal display device that displays multiple pieces of information in the same direction of the operator's eyes while maintaining clarity between the individual displays.

### BACKGROUND OF THE INVENTION

This invention relates to a liquid crystal display (LCD) device having a liquid crystal screen as a display section, and more particularly to a segmental display type liquid crystal display device that has mixed multiple liquid crystal display sections in a single sheet of a liquid crystal display panel and wherein undesired variations in between the display output is minimized.

As is well known, a wide variety of LCD devices are employed, for example in transportation vehicles of many types to provide a variety of information to the vehicle operator and/or occupants thereof. A typical example of such display devices is shown in Japanese Published Application Hei 9-50010 and employs a single panel having multiple common electrode lines and segment electrode lines that extend normally to each other in a matrix shape. Intersection portions thereof are selectively applied with a voltage from both of the electrode lines to drive the liquid crystals on the intersection portions. Thus light of a backlight is either allowed to permeate or is shut off to display an expected image or characters. On this occasion, the liquid crystal panel is driven, for example, in a drive method referred to as a line sequentially driving method.

With this method, a voltage is sequentially applied to the multiple common electrode lines to drive the liquid crystals on the intersection portions from the segment electrode lines. Thus, an activating time per common electrode line becomes shorter as the number of the electrode lines increases. That is, an actual duty ratio decreases. As a result, with an increase in the number of the common lines, the effective value of the voltage applied to the respective picture elements becomes smaller. This has the effect of lowering the contrast as a whole.

As described in that published application a liquid crystal drive method is employed where the common electrodes are divided into multiple selected groups. Scanning electrode lines are driven in each selected group and a segment signal line drive circuit outputs a segment signal electrode drive signal synchronously with the selected group drive to vary the drive voltage ratio at on and off operations of the voltage. Thus it is hoped that this liquid crystal drive method will prevent a fall off of the contrast.

In this construction the display section of the liquid crystal display device is formed from a single sheet of a liquid crystal panel. The aforenoted drive circuit controls the entire liquid crystal display of the panel. Thus, if part of the display that displays a fixed image pattern having a small number of common electrodes such as by way of example seven-segment pattern (numerals or the like), and another part displays an optional image pattern (for example, pictures or characters) having a large number of common electrodes as represented by a large screen doted matrix, the single screen can simultaneously provide multiple pieces of information. The single liquid crystal panel thus can be a liquid crystal display device that has good visibility and convenience.

However with this device, because a whole screen of the conventional liquid crystal panel is driven by a single drive circuit, the same voltage is applied to display sections that have different common electrodes in number and accordingly have different duties. Thus, according to the line sequentially driving method described above, due to the difference in number of the common lines among the display sections, the activating times of the voltage applied to the respective common electrodes that form respective display sections are different. Therefore respective contrasts or response speeds differ from each other between the display sections and the screen becomes indistinct.

In addition the prior art displays frequently position the adjacent edges of the display sections so that there is not a clear straight line division between them which further tends to make the display difficult to read.

Therefore it is a principal object of this invention to provide a display driver arrangement for separate sections of a common liquid crystal display having which multiple display sections for displaying different characteristics in a single screen so that contrasts and/or response speeds do not differ from each other so that the screen has good visibility and readability.

### SUMMARY OF THE INVENTION

One feature of this invention is adapted to be embodied in a having a screen formed from a single liquid crystal panel that is divided into a plurality of mixed liquid display sections. In accordance with this feature at least some of said liquid display sections having different number of common electrodes, an independent drive circuit for each of said some liquid display sections.

In accordance with another feature of the invention, the independent drive circuits apply different drive voltages to their respective liquid display sections.

In accordance with still another feature of the invention, edges of adjacent liquid crystal display sections are separated from the other in such a way that neither one even partially encircles the other to maintain a clear demarcation between them.

### BRIEF DESCRIPTION OF THE DRAWINGS

FIG. 1 is a schematic view of a liquid crystal display for having a plurality of sections that display characteristics different from each other with contrasts and display speeds that are the same so as to provide easy readability.

FIG. 2 is a graph showing the relationship between contrast, duty ratio and drive voltage of the different sections to show how the result is achieved.

### DETAILED DESCRIPTION

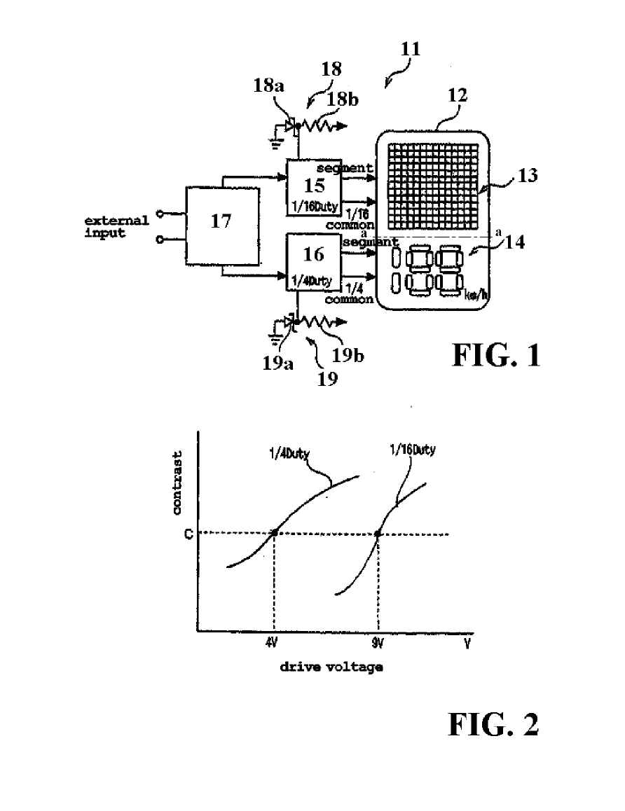

Referring now in detail to the drawings and initially to FIG. 1 a liquid crystal display device embodying the invention is indicated generally by the reference numeral 11. The display device 11 has display in the form as a liquid crystal panel 12, as a display means. The liquid crystal panel 12 is configured as a dotted matrix formed with a desired numbers of picture elements. By of example of the possible alternatives this includes a first liquid crystal display section 13 that displays characters, pictures or the like and a second liquid crystal display section 14 for displaying patterns that are fixed to a certain extent such as numerical values of a vehicle speed (for example, a seven-segment pattern).

The first liquid crystal display section 13 is a display section which has a large number of common electrodes and its duty cycle is small (the activating time per one electrode is short). On the other hand, the second liquid crystal display section 14 is a display section provided with a small number of common electrodes and having a large duty cycle (the activating time per one electrode is long).

The first liquid crystal display section 13 includes segment electrodes and common electrodes (not shown) inside thereof. The numbers of both electrodes correspond to the dotted matrix picture element lines. Those electrodes are driven with segment signals (voltage) and common signals (voltage) outputted from a first display section drive circuit 15 disposed corresponding thereto. Specifically, the first display section drive circuit 15 includes: a segment driver (not shown) that can output, for example, picture element imposing pulses (the segment signals) corresponding to an image output command that comes from a control circuit cycle 17 which will be described later; and a common driver (not shown) that regularly outputs, for example, 16 picture element imposing pulses (the common signals) per unit time (i.e., 1/16 duty).

On the other hand, the second liquid crystal display section 14 includes segment electrodes corresponding to the number of the display segments (if one numeral, seven-segments) and common electrodes (not shown) inside thereof. These electrodes are driven with segment signals (voltage) and common signals (voltage) outputted from a second display section drive circuit 16 disposed corresponding thereto. Similarly to the first display drive circuit 15, the second display section drive circuit 16 includes: a segment driver (not shown) that can output, for example, picture element imposing pulses (the segment signals) corresponding to an image output command that comes from a control circuit 17 which will be described later; and a common driver (not shown) that an regularly output, for example, four picture element imposing pulses (the common signals) per unit time (i.e., 1/4 duty).

The signal output to the liquid crystal panel 12 from the first display section drive circuit 15 and the second display section drive circuit 16 is controlled by a control circuit 17 which receives image data and processes them. This control circuit 17 carries out a certain calculation on the image data inputted from outside sensors (not shown), and outputs signals to drive the respective segment drivers and the respective common drivers of the first display section drive circuit 15 and the second display section drive circuit 16. Also, the control circuit 17 has a memory for storing patterns (characters, pictures or the like) to be displayed by the dotted matrix of the first liquid crystal display section 15. The control circuit 17 is triggered with a signal input from the outside sensor to read an appropriate pattern from the memory and outputs segment driver and common driver's drive signals corresponding thereto.

Additionally, the control circuit 17 can directly drive the drivers with a command signal input from outside sensors. The pictures or the characters are displayed by driving both of the drivers as described above to select picture elements on matrix intersection points corresponding to the command image and applying the voltage.

As described, the liquid crystal display device 11 of the present embodiment has the first liquid crystal display section 13 that displays with the common signals of 1/16 duty cycle and the second liquid crystal display section 14 that displays with the common signals of 1/4 duty cycle. If the power source voltages supplied to the respective display sections were the same as one another, the activating times of the voltages applied to the common electrodes of the respective sections would be different from each other because of the difference of the duty division numbers. These appear as the difference of the contrast or the response speed in the display sections 13, 14, and would result in an indistinct image outputting form.

To avoid such a problem, the liquid crystal display device 11 of the embodiment has a first reference voltage circuit 18 and a second reference voltage circuit 19 both of which supply different reference voltages for driving the respective first display section drive circuit 15 and the second display drive circuit 16 in complying with characteristics of the corresponding respective display sections. Specifically, the first reference voltage circuit 18 is set to generate a reference voltage that is higher than the same of the second display section drive circuit 16 to compensate the shortness of the activating time described above, i.e., to equalize effective voltage values (applied voltage application time) regarding the common electrodes of the respective display sections 13, 14.

In other words, the second reference voltage circuit 19 is set to generate a voltage smaller than the set voltage of the first reference voltage circuit 18 to compensate the length of the activating times described above in complying with the common signal output characteristic (1/4 duty). Additionally, the first reference voltage circuit 18 includes a Zener diode 18a for generating the fixed voltage described above and a resistor 18b, and also the second reference voltage circuit 19 includes a Zener diode 19a for generating the fixed voltage and a resistor 19b.

The effect of this may be best understood by reference to FIG. 2. This is a graph showing output characteristics of the respective drive circuits 15, 16 and specifically the relationships between the duty ratios of the outputted common signals, the drive circuit drive voltage, and the contrast in the display sections.

As is apparent from FIG. 2, in order to equalize the contrasts of the different display sections, the larger the duty division number of the common signal, the larger the voltage that is necessary to drive. In the embodiment, the liquid crystal display sections 13, 14 are driven with respective reference drive voltages such as nine volts for the first display section drive circuit 15 having 1/16 duty and four volts for the first display section drive circuit 15 having 1/4 duty to achieve, for example, the same contrast value C in both of the liquid crystal display sections 13, 14. Thus, the first reference voltage circuit 18 needs to have the Zener diode 18a that generates the reference voltage of nine volts, while the second reference voltage circuit 19 needs to have the Zener diode 9a that generates the reference voltage of four volts.

Therefore, although the first and second liquid crystal display sections 13, 14 have different image output forms due to the different duties, the display sections 13, 14 output respective image patterns with the same contrast, and the entire screen can provide good visibility. Also, the response speeds of the respective display sections 13, 14 are in the same condition as the contrasts. Thus the display sections 13, 14 can output images with the same response speed by the settings of the reference voltages described. Further, the response speed can be the same also because the display sections 13, 14 are formed with a single liquid crystal panel.

In addition and as shown by the phantom line a-a in FIG. 1, it will be seen that a straight line forms the boundary edge between the separate sections 13 and 14 so there is no overlap and the distinction between the displays 13 and 14 is not obscured.

As has been described and in accordance with the present invention, the multiple display sections that have different duties and are mixed in the same liquid crystal panel and are driven with the appropriate drive voltages to complying with their output characteristics. Thus, the contrasts and the response speeds will be the same between the display sections. The liquid crystal display device that has good visibility over the entire screen can be provided, accordingly. Additionally, although the device that mixes two display sections in one panel screen is illustrated in the present embodiment, of course the numbers are not limited, and reference voltage circuits can vary in accordance with the number of the display sections. Further, although the Zener diodes are used as the voltage generating source of the reference voltage circuit in the illustrated embodiment, other voltage generating elements may be used.

From the foregoing description, it should be apparent that the present invention can be effectively applied to a liquid crystal display device that needs to display multiple pieces of vehicle information in the same direction of the operator's eyes, such as an instrument disposed in a dashboard of a vehicle like a speedometer, tachometer and shift position indicator. Also, the present invention can be applied to a public information display device or a large-sized liquid crystal screen those which display information to numbers of people. Of course those skilled in the art will readily understand that the described embodiments are only exemplary of forms that the invention may take and that various changes and modifications may be made without departing from the spirit and scope of the invention, as defined by the appended claims.

1. A liquid crystal display device having a screen formed from a single liquid crystal panel that is divided into a plurality of mixed liquid display sections, at least some of said liquid display sections having different number of common electrodes, an independent drive circuit for each of said some liquid display sections.

2. A liquid crystal display device as set forth in claim 1 wherein the independent drive circuits apply different drive voltages to their respective liquid display sections.

3. A liquid crystal display device as set forth in claim 2 wherein the drive voltage supplied by its drive circuit to a liquid crystal display section having a smaller number of the common electrodes is smaller than that applied to by its drive circuit to a liquid crystal display section having a large number of the common electrodes.

4. A liquid crystal display device as set forth in claim 1 wherein edges of adjacent liquid crystal display sections are separated from the other in such a way that neither one even partially encircles the other to maintain a clear demarcation between them.

5. A liquid crystal display device as set forth in claim 4 wherein the independent drive circuits apply different drive voltages to their respective liquid display sections.

6. A liquid crystal display device as set forth in claim 5 wherein the drive voltage supplied by its drive circuit to a liquid crystal display section having a smaller number of the common electrodes is smaller than that applied to by its drive circuit to a liquid crystal display section having a large number of the common electrodes.
